(19) United States
(12) Patent Application Publication
(10) Pub. No.: US 2005/0086642 A1
(43) Pub. Date: Apr. 21, 2005

(54) Tools providing for backwards compatible software

(76) Inventors: Martin Runte, Darmstadt (DE); Thomas Decker, Rauenberg (DE); Rainer Hueber, Hockenheim (DE); Juergen Remmel, Muelhausen (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/687,233

(22) Filed: Oct. 15, 2003

(51) Int. Cl. G06F 9/44

(52) U.S. Cl. 717/122

(57) ABSTRACT

A method and apparatus for providing tools for development of backwards compatible software are disclosed. A subset of software objects of a first software subsystem is identified and declared frozen. A changed introduced into a frozen software object is detected and prior to allowance of the change, the change is analyzed to determine whether the change is compatible with a second software subsystem.

### FIELD OF THE INVENTION

Embodiments of the invention pertain to the fields of software development. More particularly, embodiments of the invention relate to developing backwards compatible software modules.

### BACKGROUND OF THE INVENTION

Complex software systems usually include a variety of components, subsystems, etc. that are updated by developers at different stages of software product development. An interaction between different subsystems of a software product may depend on certain components remaining unchanged, otherwise incompatible changes may introduce a variety of errors into an execution of the software product. For example, changed parameters of a function, which is called by several other software components, may introduce errors into a software system, if the other software components are not changed to reflect the changed function parameters. However, it may be desirable to be able to modify a subsystem of the software product without affecting the performance of other subsystems.

Currently, there are no solutions available in the industry that ensure unchanged software objects of a software product will remain compatible with new versions of other objects of the software product.

What is needed, therefore, is a solution that overcomes these and other shortcomings of the prior art.

### SUMMARY OF THE INVENTION

A method and apparatus for developing backwards compatible software are disclosed. Embodiments of the invention include identifying a subset of software objects of a first software subsystem and declaring the subset of software objects frozen. Embodiments of the invention further include detecting a change to be introduced into a frozen software object from the subset of software objects, and prior to allowing the change determining whether the change is compatible with a second software subsystem.

### BRIEF DESCRIPTION OF THE DRAWINGS

The invention is illustrated by way of example and not limitation in the figures of the accompanying drawings, in which like references indicate similar elements and in which:

FIG. 1 illustrates a system architecture according to one embodiment of the invention;

FIG. 2 illustrates components of a server according to one embodiment of the invention;

FIG. 3 illustrates components of a client according to one embodiment of the invention;

FIG. 4 illustrates an exemplary processing system according to one embodiment of the invention;

FIG. 5 is a flow diagram of frozen objects declaration process according to one embodiment of the invention;

FIG. 6 is a flow diagram of a compatibility check process according to one embodiment of the invention;

FIG. 7 is a flow diagram of a global compatibility check process according to one embodiment of the invention; and

FIG. 8 illustrates multiples subsystems according to one embodiment of the invention.

### DETAILED DESCRIPTION

A method and apparatus for backwards compatible software development are described. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those skilled in the art. Thus, the invention can include any variety of combinations and/or integrations of the embodiments described herein.

It will be appreciated that the term “software”, as used herein, means a software system including independent subsystems, which may or may not be located on several machines, e.g. client machines and server machines. The term “object”, as used herein, means a software object including, but not limited to, function modules, programs, data objects, classes, class components, interfaces, attributes, etc. It will also be appreciated that the term “frozen objects”, as used herein, means software objects of a software subsystem that are used by the objects of another software subsystem and that should not be changed without approval to ensure compatible software functionality.

Exemplary Architecture

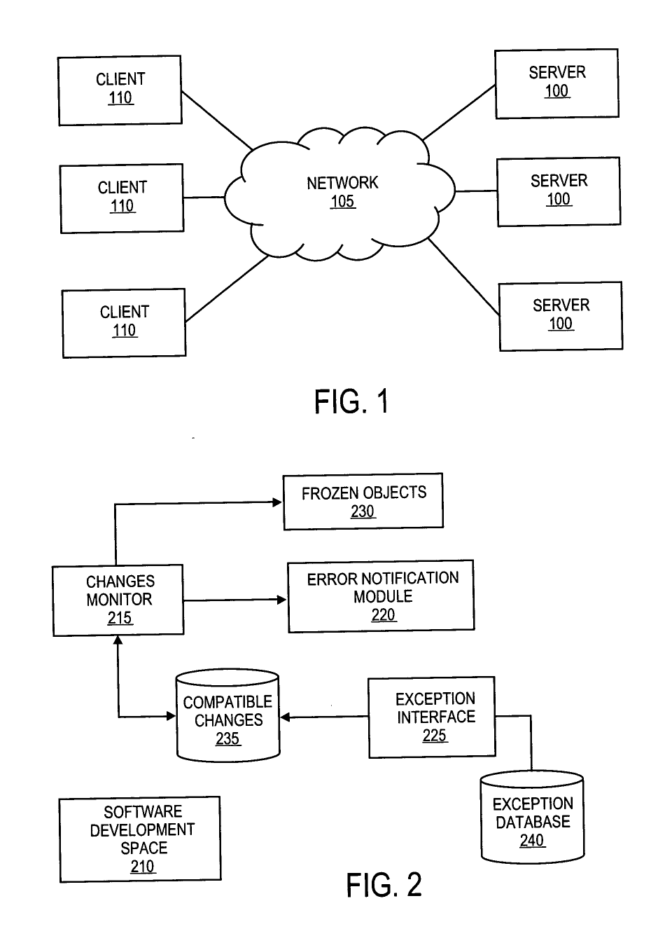

FIG. 1 illustrates an exemplary system environment in which the described method and apparatus can be implemented according to one embodiment of the invention. A plurality of clients 110 communicate with a plurality of servers 100 via a network 105, e.g. the Internet.

Components of a server 100 are illustrated in FIG. 2 according to one embodiment of the invention. The server includes a software development space 210 that provides a software developer with necessary tools for developing software code, for example, editors, compilers, etc. The server also includes compatibility check tools to ensure that new changes introduced by developers to software objects are compatible with other software objects. The server includes a changes monitor 215 that monitors software code development performed by the developer within the software development space. Frozen objects 230 is another component of the server, which includes identifications of software objects that are declared frozen, e.g., objects that if modified may introduce incompatible changes. In one embodiment frozen objects include software objects and their environments that are used by a software product subsystem located at the client 110. The server also includes a compatible changes database 235, which includes changes that are predefined as compatible changes. The server also includes an error notification module 220, an exception interface 225 and an exception database 240, the functions of which are described below.

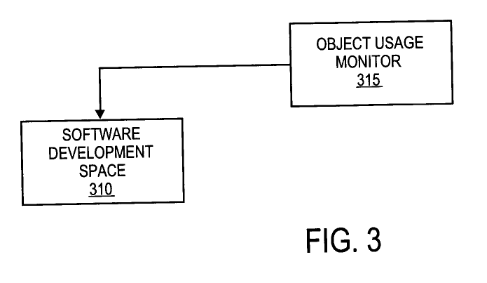

FIG. 3 illustrates components of the client 110 according to one embodiment of the invention. The client 110 includes a software development space 310 providing a software developer with necessary tools for software development, such as editors, compilers, etc. The client 110 also includes an object usage monitor 315, the functions of which will be apparent from the following description.

Methodology

With these concepts in mind embodiments of the invention may be further described. An exemplary software system including subsystem 1 and subsystem 2, wherein subsystem 1 is located at the server and subsystem 2 is located at the client, is used in the following description for ease of understanding of the invention. However, it will be appreciated that the invention is not limited to the software product with only two subsystems and the software product may include multiple subsystems. Moreover, the invention is not limited to any location of the subsystems of the software product, and all the subsystems may reside, for example, on a single machine.

Development of Frozen Objects

As stated above objects of the software product are declared frozen according to one embodiment of the invention. The software product may include several software subsystems, for example subsystem 1 and subsystem 2, wherein subsystem 2 uses certain objects of subsystem 1. It may be desirable to ensure that changes made to subsystem 1 do not affect subsystem 2. In this situation software objects of subsystem 1 that are used by subsystem 2 are declared frozen. Frozen objects are identified in the frozen objects table 230 at the server, which hosts subsystem 1.

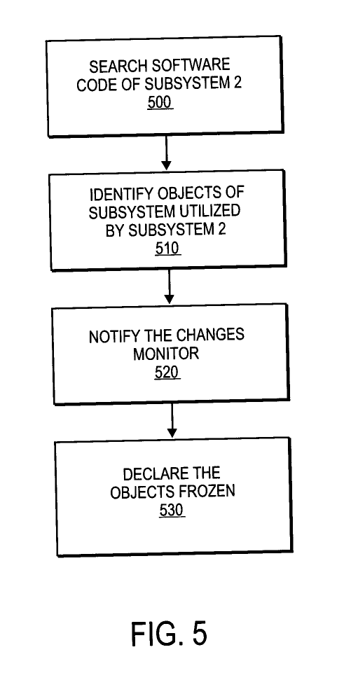

In order to identify the objects of subsystem 1 that are used by the subsystem 2, according to one embodiment of the invention, the object usage monitor 315 at 500 of FIG. 5 searches the software code located in the software development space 310 at the client for usage of software objects of the subsystem 1, e.g., function calls, data structure usage, etc. Upon identification of the objects at 510, the object usage monitor 315 at 520 notifies the changes monitor 215 at the server. The used software objects are then declared by the changes monitor 215 to be frozen objects and identified in the frozen objects table 230 at 530 of FIG. 5.

In one embodiment the changes monitor 215 ensures that the environment of the identified frozen objects is frozen as well, for example, the data domain of a data object used by the subsystem 2 is declared frozen by the changes monitor 215.

Compatibility Check

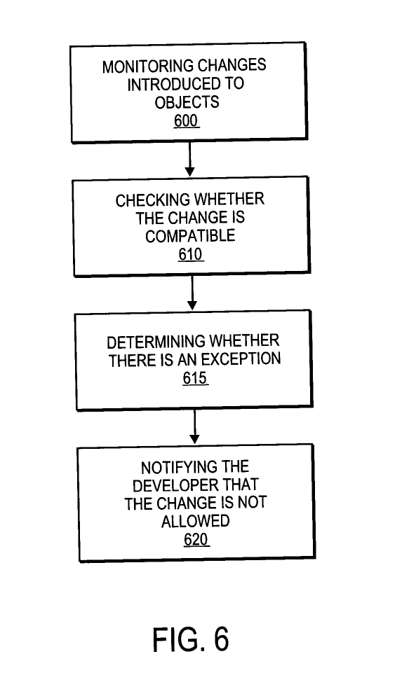

In one embodiment the changes monitor 215 monitors and detects changes introduced by the developer to the frozen software objects of the subsystem 1 at 600 of FIG. 6, which is a flow diagram of compatibility check process. The changes may be detected while the developer is typing the change using an editor, or alternatively, the change may be detected during the compilation of a software object, which developer changed. Upon detecting a change being introduced into a frozen software object, at 610, the changes monitor 215 accesses the compatible changes database 235 to determine whether the change that the developer is trying to introduce to the object is predefined as compatible. For example, the compatible changes database 235 may include a declaration that adding an optional importing parameter to a function is a compatible change. If the change is not defined in the compatible changes database 235, the changes monitor 215 at 615 determines whether there is an exception allowing the developer to make the change. In one embodiment exceptions are entered by an expert in compatibility between the subsystems of the software product upon receiving a request submitted by the software developer. If the exception is not present, the changes monitor 215 invokes an error notification module 220 to notify the developer at 620 that the change that the developer is attempting to introduce into the object is not allowed.

Upon receiving notification that a change is not allowed, the developer may contact an individual who is an expert in compatibility between subsystems of the software product according to one embodiment of the invention. The expert reviews the change that the developer is proposing to make and analyzes whether the change will introduce incompatibility problems into the software product. If the expert determines that the change will not introduce incompatibility problems, the expert enters an exception into an exception database 240 via the exception interface 225. The exception will be identified by the changes monitor 210 if the developer again tries to introduce the change to the frozen object.

In one embodiment, the function of the expert described above are automated and performed by a software routine implementing an algorithm performing compatibility checks of frozen objects proposed to be changed by the developer.

In one embodiment of the invention, if the expert determines that the change can be predefined as compatible, the expert directs the system to include the change into the compatible changes database 235.

Classification of Frozen Objects

In one embodiment of the invention, the frozen objects include released objects and restricted objects. The released objects are used by objects of the subsystem 2. In addition, the released objects can be used by objects of the subsystem 2 without any restrictions allowing any type of usage of the released objects. Because a large number of objects of subsystem 2 may use the released objects and because any type of potential usage is possible by the objects of the subsystem 2, such as inheritances from a class or usage of a data structure as part of another data structure, rendering manual check for compatibility errors virtually impossible, no changes are allowed to be made to the released objects according to one embodiment. Alternatively, changes may be introduced to the released objects only with permission of the expert.

The restricted objects are used by a relatively smaller group of objects of the subsystem 2. In one embodiment the server includes a restricted objects table identifying objects of the subsystem 2 utilizing the restricted objects. The restricted objects table may be used by the expert to identify objects that may be affected by a proposed change, when determining whether the proposed change will cause compatibility errors.

In one embodiment the classification of the frozen objects is based on a number of times a particular frozen object is used by the subsystem 2. The object usage monitor 315, during the identification process of the objects of the subsystem 1 that are used by the subsystem 2, may also count instances of usage of each identified object. The number of instances may then be transmitted to the server along with the identification of the objects. The changes monitor 215 classifies frozen objects by determining whether the number of instances for each particular object exceeds a predetermined threshold. If the number of instances exceeds the predetermined threshold then the object is classified as a released object, if the number of instances does not exceed the predetermined threshold then the object is classified as a restricted object.

Usage of the Objects

In one embodiment of the invention, the object usage monitor 315 identifies when a developer attempts to add a new usage of a restricted object by an object of the subsystem 2. The object usage monitor 315 informs the developer that prior to allowing the addition of the new usage, the developer needs to submit a request for adding the new usage to the changes monitor 215 at the server. Upon receiving a request for the new usage instance, the changes monitor adds the new object of the subsystem 2 to the restricted objects table. In addition, the changes monitor determines whether any changes were recently made to the restricted object. If the changes to the restricted object were made, then the changes monitor 215 notifies the developer to ensure that the developer is aware of all the recent changes to eliminate any compatibility errors.

In one embodiment, the changes monitor 215, upon receiving a request for a new usage of a restricted object, determines whether the number of instances of usage of the restricted object exceeds the threshold with the addition of the new usage. If the threshold is exceeded the restricted object may be re-classified as released.

In one embodiment, the object usage monitor 315 identifies when a developer attempts to add a new usage of a non-frozen object of the subsystem 2. The object usage monitor 315 informs the developer that prior to allowing the addition of the new usage, the developer needs to submit a request for adding the new usage to the changes monitor 215 at the server. Upon receiving a request for the new usage, the changes monitor 215 freezes the object of the subsystem 2 by declaring it to be a restricted frozen object.

Global Compatibility Check

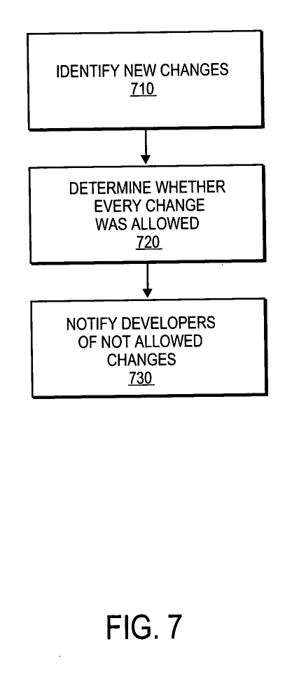

In one embodiment of the invention, the changes monitor 215 performs a global compatibility check to ensure that no changes have been introduced into the system that may introduce incompatibility errors since the last global compatibility check. At 710 of FIG. 7 the changes monitor 215 identifies new changes by comparing the latest version of the frozen objects in the software development space with the version of the frozen objects at the time of the last global check. At 720 the changes monitor 215 determines whether every identified change to the frozen objects was determined to be compatible and allowed to be made either dynamically using the compatible changes database or by the knowledgeable entity. If a change is identified that was not approved either automatically or by the knowledgeable entity, the changes monitor 215 at 730 notifies the developer responsible for the frozen object that includes an unapproved change. In addition, the changes monitor 215 at 730 notifies the developers responsible for objects of the subsystem 2 that use the frozen object with the unapproved change to ensure that the developers preserve compatibility by determining whether any changes need to be made to any of the objects of the subsystem 1 and/or subsystem 2.

Centralized Compatibility Check for Multiple Subsystems

In one embodiment of the invention, the server hosts several subsystems that are used by the objects at the client. In this embodiment the server includes a master system that provides a centralized compatibility check for all the subsystems located at the server. The master system performs all the functions described above for the subsystems at the server.

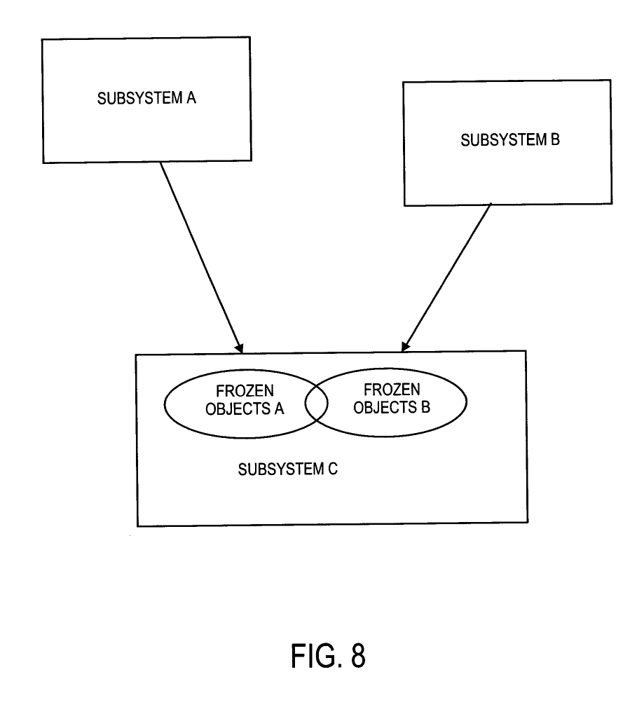

It will be appreciated that multiple subsystems located at a client may use multiple subsystems located at a server. In one embodiment an interaction between each pair of two subsystems is associated with a declaration of frozen objects, i.e. objects of one subsystem used by the other. Multiple subsystems using objects of a single subsystem may cause the subsets of the frozen objects to overlap as illustrated in FIG. 8. In order to ensure that compatibility check is performed in an efficient manner, in one embodiment the master system described above is used to ensure compatibility checks for all the subsets of the frozen objects.

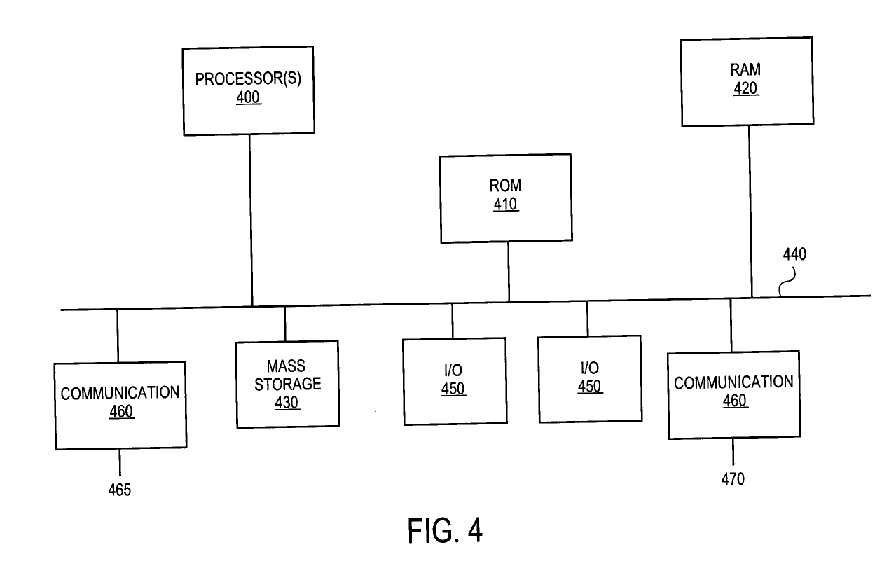

It will be appreciated that physical processing systems, which embody components of the software development tools mentioned above, may include processing systems such as conventional personal computers (PCs), embedded computing systems and/or server-class computer systems according to one embodiment of the invention. FIG. 4 illustrates an example of such a processing system at a high level. The processing system of FIG. 4 may include one or more processors 400, read-only memory (ROM) 410, random access memory (RAM) 420, and a mass storage device 430 coupled to each other on a bus system 440. The bus system 440 may include one or more buses connected to each other through various bridges, controllers and/or adapters, which are well known in the art. For example, the bus system 440 may include a ‘system bus’, which may be connected through an adapter to one or more expansion buses, such as a peripheral component interconnect (PCI) bus or an extended industry standard architecture (EISA) bus. Also coupled to the bus system 440 may be the mass storage device 430, one or more input/output (I/O) devices 450 and one or more data communication devices 460 to communicate with remote processing systems via one or more communication links 465 and 470, respectively. The I/O devices 450 may include, for example, any one or more of: a display device, a keyboard, a pointing device (e.g., mouse, touch pad, trackball), and an audio speaker.

The processor(s) 400 may include one or more conventional general-purpose or special-purpose programmable microprocessors, digital signal processors (DSPs), application specific integrated circuits (ASICs), or programmable logic devices (PLD), or a combination of such devices. The mass storage device 430 may include any one or more devices suitable for storing large volumes of data in a non-volatile manner, such as magnetic disk or tape, magneto-optical storage device, or any of various types of Digital Video Disk (DVD) or Compact Disk (CD) based storage or a combination of such devices.

The data communication device(s) 460 each may be any device suitable to enable the processing system to communicate data with a remote processing system over a data communication link, such as a wireless transceiver or a conventional telephone modem, a wireless modem, an Integrated Services Digital Network (ISDN) adapter, a Digital Subscriber Line (DSL) modem, a cable modem, a satellite transceiver, an Ethernet adapter, Internal data bus, or the like.

Conclusion

It will be recognized that many of the features and techniques described above may be implemented in software. For example, the described operations may be carried out in a processing system in response to its processor(s) executing sequences of instructions contained in memory of the device. The instructions may be executed from a memory such as RAM and may be loaded from a persistent store, such as a mass storage device, and/or from one or more other remote processing systems. Likewise, hardwired circuitry or firmware may be used in place of software, or in combination with software, to implement the features described herein. Thus, the invention is not limited to any specific combination of hardware circuitry and software, nor is it limited to any particular source of software executed by the processing systems.

Thus, a method and apparatus for backwards compatible software development. Although the invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative sense rather than a restrictive sense.

1. A computer-implemented method comprising:
detecting a change introduced into a software object of a first software subsystem, wherein the software object is used by software objects of a second software subsystem;
allowing the change if the change is compatible with the objects of the second software subsystem without introducing any changes into the software objects of the second software subsystem.

2. The method of claim 1 further comprising determining whether the change is predefined as compatible.

3. The method of claim 2 further comprising allowing the change if the change is predefined as compatible.

4. The method of claim 3 further comprising issuing a message that the change is not allowed if the change is not predefined as compatible.

5. The method of claim 4 further comprising allowing the change if an expert declares the change compatible upon receiving a request for a manual compatibility check, wherein the change is not predefined as compatible.

6. A computer-implemented method comprising:
identifying a subset of software objects of a first software subsystem and declaring the subset of software objects frozen;
detecting a change introduced into a frozen software object from the subset of software objects, and prior to allowing the change determining whether the change is compatible with a second software subsystem.

7. The method of claim 6 wherein the subset of software objects declared frozen includes software objects of the first software subsystem that are used by the second software subsystem.

8. The method of claim 7 wherein frozen objects are classified to include released objects and restricted objects.

9. The method of claim 8 wherein the released objects include objects that are used by the second software subsystem without restrictions.

10. The method of claim 8 wherein the restricted objects include objects that are used by a small number of objects of the second software subsystem.

11. The method of claim 8 wherein an identification of recent changes introduced into a restricted object is provided when objects of the second software subsystem request new usage of the restricted object.

12. The method of claim 8 wherein classification of the frozen objects is based on a number of times a frozen object is used by the second software subsystem.

13. The method of claim 6 wherein a software object is a function module.

14. The method of claim 6 wherein a software object is a data structure.

15. The method of claim 13 wherein the software object includes an environment of the function module.

16. The method of claim 6 wherein a software object includes a class and an environment of the class.

17. The method of claim 6 wherein a software object includes an interface and an environment of the interface.

18. The method of claim 6 wherein a software object includes a program and an environment of the program.

19. The method of claim 6 wherein the detecting the change comprises automatically monitoring development of software code.

20. The method of claim 6 wherein the determining whether the change is compatible comprises determining whether there is a predefined declaration of compatibility of the change.

21. The method of claim 7 wherein the determining whether the change is compatible comprises determining whether an expert declared the change compatible.

22. A computer-implemented method comprising:
performing a global compatibility check of software objects of a first software subsystem by determining whether any changes were introduced into a subset of the software objects of the first software subsystem since the time of a last compatibility check, wherein the introduced changes were introduced without obtaining prior approval;
identifying software objects of a second software subsystem affected by an unapproved change, wherein the affected software objects of the second software system are software objects using at least one software object of the subset of the software objects of the first software system; and
issuing a notice of possible incompatibility between affected software objects and software objects including the unapproved change.

23. The computer-implemented method of claim 22 wherein the performing a global compatibility check comprises comparing a current version of software code with a version of the software code at a time of a last global compatibility check.

24. The method of claim 22 wherein the subset of the software objects includes frozen software objects.

25. The method of claim 24 wherein the frozen software objects include objects of the first software subsystem used by objects of the second software subsystem.

26. An apparatus comprising:
a changes monitor to automatically detect a change introduced into a software object of a first software subsystem, wherein the software object is used by objects of a second software subsystem, and the changes monitor to allow the change if the change is compatible with the objects of the second software subsystem without introducing any changes into the objects of the second software subsystem; and
an error notification module to notify a software developer introducing the change into the object of the first software subsystem of a not allowed change if the change is incompatible.

27. The apparatus of claim 26 wherein the changes monitor to allow the change if the change is compatible comprises the changes monitor to determine whether there is a predefined declaration of compatibility of the change.

28. The apparatus of claim 26 wherein the change monitor to allow the change if the change is compatible comprises the changes monitor to determine if an expert declares the change compatible upon receiving a request for a manual compatibility check, wherein the change is not predefined as compatible.

29. The apparatus of claim 26 further comprising a master system including the changes monitor to detect a change introduced into a software object of a first software subsystem from a plurality of software subsystems.

30. The apparatus of claim 26 wherein the first software subsystem is located at a server.

31. The apparatus of claim 26 wherein the second software subsystem is located at a client.

32. An article of manufacture comprising:
a storage medium having stored therein instructions which, when executed by a processor, cause a processing system to perform a method comprising:
detecting a change introduced into a software object of a first software subsystem, wherein the software object is used by software objects of a second software subsystem;
allowing the change if the change is compatible with the objects of the second software subsystem without introducing any changes into the software objects of the second software subsystem.

33. The article of manufacture of claim 32 wherein the instructions, which when executed by the processor, cause the processing system to perform the method further comprising determining whether the change is predefined as compatible.

34. The article of manufacture of claim 32 wherein the instructions, which when executed by the processor, cause the processing system to perform the method wherein the method further comprising issuing a notification that the change is not allowed if the change is not predefined as compatible.

35. The article of manufacture of claim 32 wherein the instructions, which when executed by the processor, cause the processing system to perform the method wherein the method further comprising allowing the change if an expert declares the change compatible upon receiving a request for a manual compatibility check, wherein the change is not predefined as compatible.

36. An apparatus comprising:
means for detecting a change introduced into a software object of a first software subsystem, wherein the software object is used by software objects of a second software subsystem;
means for allowing the change if the change is compatible with the objects of the second software subsystem without introducing any changes into the software objects of the second software subsystem; and
means for issuing a notice of a not allowed change if the change is not compatible.

37. The apparatus of claim 36 further comprising means for allowing the change further comprise means for determining whether the change is predefined as compatible.

38. The apparatus of claim 36 wherein means for allowing the change further comprise means for allowing the change if an expert declares the change compatible upon receiving a request for a manual compatibility check, wherein the change is not predefined as compatible.
